(19) United States
(12) Patent Application Publication
(10) Pub. No.: US 2025/0168924 A1
(43) Pub. Date: May 22, 2025

(54) SERVER APPARATUS, COMMUNICATION CONTROL METHOD, TERMINAL APPARATUS, AND BASE STATION

(71) Applicant: HONDA MOTOR CO., LTD., Tokyo (JP)

(72) Inventors: Takafumi Saito, Tokyo (JP); Kenji Nakanishi, Tokyo (JP)

(73) Assignee: HONDA MOTOR CO., LTD., Tokyo (JP)

(21) Appl. No.: 19/008,236

(22) Filed: Jan. 2, 2025

Related U.S. Application Data
(63) Continuation of application No. PCT/JP2022/027213, filed on Jul. 11, 2022.

(51) Int. Cl. H04W 76/28; H04W 4/40; H04W 64/00

(52) U.S. Cl. CPC H04W 76/28; H04W 4/40; H04W 64/00

(57) ABSTRACT

There is provided a server apparatus including a communication unit to communicate with one or more terminal apparatuses that operate as clients of a V2X application, and a server processing unit to operate as a server of the V2X application. The server processing unit is capable of accessing a database indicating a risk level for each geographical area predefined for the V2X application. The server processing unit receives location information of a first terminal apparatus via the communication unit, determines, on the basis of the location information, that the first terminal apparatus is located in a first geographical area of the plurality of geographical areas, and when the database indicates that a risk level of the first geographical area is high, notifies the first terminal apparatus that it is not allowed to operate in a discontinuous reception mode.

### CROSS-REFERENCE TO RELATED APPLICATION(S)

This application is a continuation of International Patent Application No. PCT/JP2022/027213 filed on Jul. 11, 2022, the entire disclosure of which is incorporated herein by reference.

### BACKGROUND OF THE INVENTION

### Field of the Invention

The present invention relates to a server apparatus, a communication control method, a terminal apparatus, and a base station.

### Description of the Related Art

In a fourth generation cellular communication technology, also referred to as Long Term Evolution (LTE) standardized by the third generation partnership project (3GPP), it is assumed that a sidelink, which is a direct radio link between terminals, is used for vehicle-to-everything (V2X) communication (see section 5.6 of 3GPP TS 36.300 v16.7.0 (Dec. 23, 2021)). In 3GPP TS 22.185 v16.0.0 (Jul. 16, 2020), it is described that V2X may include the following four types of concepts:
V2V: Vehicle-to-Vehicle
V2I: Vehicle-to-Infrastructure
V2N: Vehicle-to-Network
V2P: Vehicle-to-Pedestrian

In a fifth generation cellular communication technology also referred to as New Radio (NR), a radio access network (RAN) supports both a V2X sidelink of 4G and an NR sidelink of 5G (see section 16.9 of 3GPP TS 38.300 v16.8.0 (Dec. 23, 2021)). For example, a terminal (also referred to as user equipment (UE)) that performs sidelink communication establishes a radio link referred to as a PC5 interface with a communication partner terminal, and performs V2X communication on a communication resource scheduled by the RAN or a communication resource autonomously selected from a resource pool assigned in advance. In the V2X sidelink of 4G, only broadcast of the V2X message is supported, whereas in the NR sidelink of 5G, broadcast, groupcast, and unicast of the V2X message are supported.

US-2020-0312142 discloses a technology in which a V2X communication-capable terminal apparatus mounted on a vehicle evaluates road safety in real time and, when it is determined that there is some threat, alerts the user of the vehicle or another user.

3GPP TR 23.776 v17.0.0 (Mar. 31, 2021), which is a technical report published by 3GPP, poses a problem that, in a scenario of V2X communication in which messages about road safety are transmitted and received, discontinuous reception (DRX) operation for reducing power consumption in a terminal may lead to loss of messages that are important in terms of safety.

3GPP TR 23.776 v17.0.0 proposes several solutions to the tradeoff between reduced power consumption and reliable transmission of safety messages in terminals participating in V2X communication. One of them is that a V2X application operating on the terminal determines whether to transition to the DRX mode on the basis of the latest road conditions. However, since information that can be collected by the terminal is limited, if the determination as to whether to transition to the DRX mode is left to the terminal, a situation in which the safety of the user cannot be sufficiently secured may occur.

### SUMMARY OF THE INVENTION

In view of the above points, the present disclosure aims to provide a mechanism capable of further improving safety of a user related to road traffic.

According to the present disclosure, there is provided a server apparatus including: a communication unit adapted to communicate with one or more terminal apparatuses that operate as clients of a vehicle-to-everything, V2X, application, and a server processing unit adapted to operate as a server of the V2X application, where the server processing unit is capable of accessing a database indicating a risk level for each of a plurality of geographical areas predefined for the V2X application, and the server processing unit is adapted to receive location information of a first terminal apparatus via the communication unit, determine, on the basis of the location information, that the first terminal apparatus is located in a first geographical area of the plurality of geographical areas, and when the database indicates that a risk level of the first geographical area is high, notify the first terminal apparatus that it is not allowed to operate in a discontinuous reception mode.

A corresponding communication control method, terminal apparatus and base station are also provided.

Further features of the present invention will become apparent from the following description of exemplary embodiments (with reference to the attached drawings).

### BRIEF DESCRIPTION OF THE DRAWINGS

FIG. 1 is a copy of Figure 16.9.1-1 of 3GPP TS 38.300 v16.8.0;

FIG. 2 is a copy of Figure 6.2-2 of 3GPP TS 23.286 v17.3.0;

FIG. 3 is a schematic diagram illustrating an example of a configuration of a V2X communication system according to an embodiment;

FIG. 4 is a block diagram illustrating an example of a configuration of a server apparatus according to an embodiment;

FIG. 5 is an explanatory diagram for describing an example of a definition of a geographical area according to an embodiment;

FIG. 6A is an explanatory diagram illustrating a first example of a message format for operation mode control;

FIG. 6B is an explanatory diagram illustrating a second example of a message format for operation mode control;

FIG. 6C is an explanatory diagram illustrating a third example of a message format for operation mode control;

FIG. 6D is an explanatory diagram illustrating a fourth example of a message format for operation mode control;

FIG. 6E is an explanatory diagram illustrating a fifth example of a message format for operation mode control;

FIG. 7 is a block diagram illustrating an example of a configuration of a UE according to an embodiment;

FIG. 8 is a block diagram illustrating an example of a configuration of a base station according to an embodiment;

FIG. 9 is a sequence diagram illustrating an example of a flow of processing according to a first embodiment example; and

FIG. 10 is a sequence diagram illustrating an example of a flow of processing according to a second embodiment example.

### DESCRIPTION OF THE EMBODIMENTS

Hereinafter, embodiments will be described in detail with reference to the attached drawings. Note that the following embodiments are not intended to limit the scope of the claimed invention, and limitation is not made an invention that requires all combinations of features described in the embodiments. Two or more of the multiple features described in the embodiments may be combined as appropriate. Furthermore, the same reference numerals are given to the same or similar configurations, and redundant description thereof is omitted.

### 1. Basic System Architecture for V2X Service

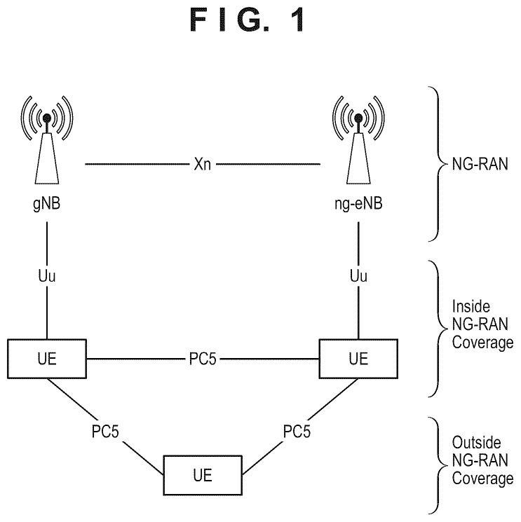

FIG. 1 is a copy of Figure 16.9.1-1 of 3GPP TS 38.300 v16.8.0, illustrating an example of an NG-RAN architecture for a 5G system. Here, a gNB is a 5G base station connected to a 5G core network (not illustrated). Meanwhile, an ng-eNB is a 4G base station connected to a 5G core network. In this example, the gNB and the ng-eNB are connected to each other via an Xn interface. A user equipment (UE) is a terminal apparatus served by the gNB or the ng-eNB. A radio link for transmitting and receiving user data between the UE and the gNB or the ng-eNB is referred to as a Uu interface. A PC5 interface is a communication link established between two UEs. Such a direct communication link between UEs that does not pass through a base station is also referred to as a sidelink. A next generation (NG)-radio access network (RAN) supports such a PC5 interface. The PC5 interface can be identified by a pair of a layer 2 ID (source layer-2 ID) assigned to the UE on the transmission side and a layer 2 ID (destination layer-2 ID) assigned to the UE on the reception side. The resource used for communication is scheduled by a base station (scheduled resource allocation), or is autonomously selected by the UE from a preset resource pool (autonomous resource selection). In the 5G system, such a PC5 interface can be utilized for the V2X service.

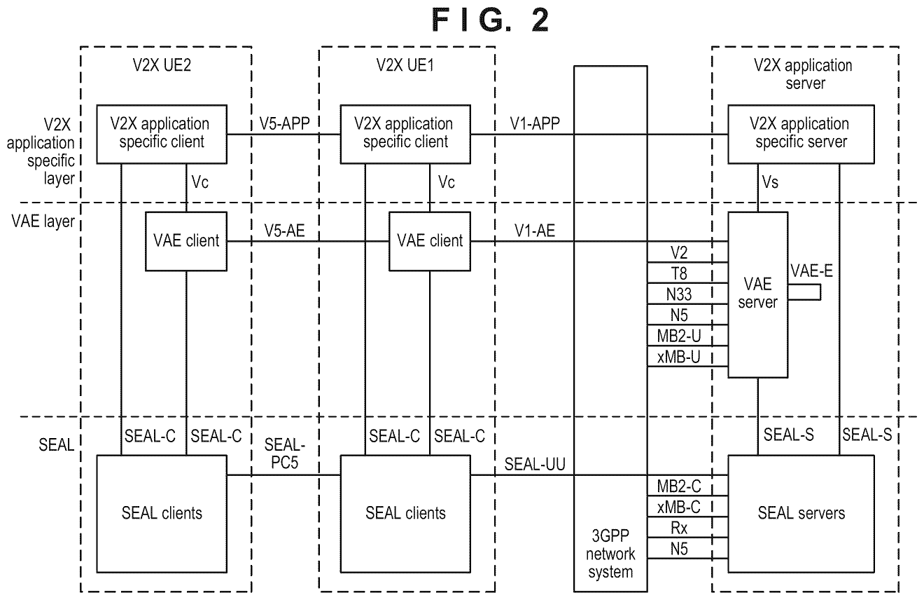

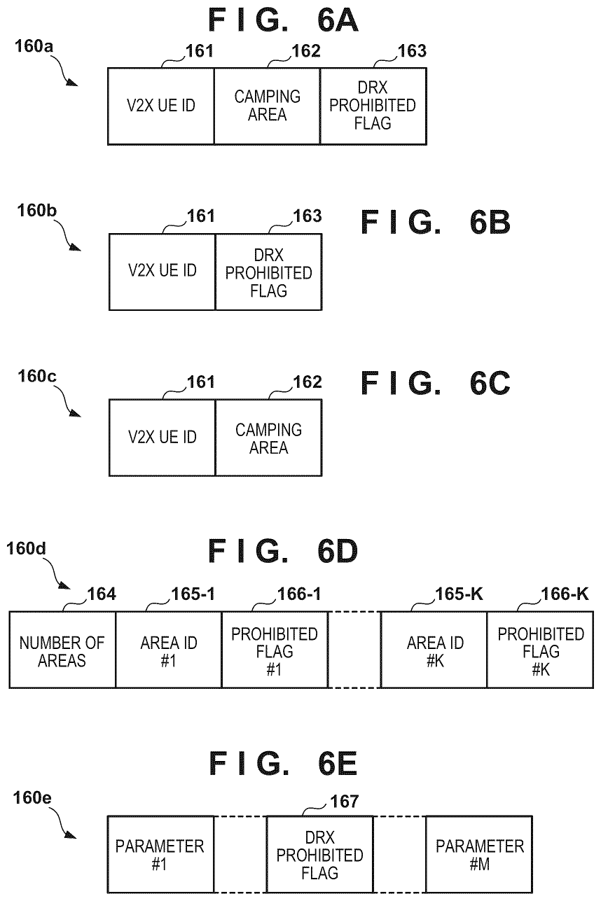

FIG. 2 is a copy of Figures 6.2-2 of 3GPP TS 23.286 v17.3.0, illustrating a hierarchical functional model of a V2X application. In the functional model of FIG. 2, the UE operates as a client (V2X UE) of the V2X application. On the other hand, a server of the V2X application is typically deployed in an Internet Protocol (IP) network and communicates with one or more V2X UEs via a 3GPP network system including a RAN and a core network. A V2X UE (V2X UE1 in FIG. 2) located inside the coverage of the NG-RAN can communicate with a V2X UE (V2X UE2 in FIG. 2) located outside the coverage via a sidelink.

The functional model of FIG. 2 has a hierarchical structure including a V2X application specific layer, a V2X application enabler (VAE) layer, and a service enabler architecture layer (SEAL) in order from the top in FIG. 2.

The SEAL is a layer that provides basic services common to various applications including V2X and other types of applications. Services related to the V2X application provided in the SEAL include, for example, location management, group management, configuration management, identity management, key management, and network resource management. The V2X UE includes SEAL clients, and the V2X application server includes SEAL servers. A SEAL-PC5 is an interface between V2X UEs in the SEAL. A SEAL-UU is an interface between a V2X UE and the V2X application server in the SEAL. Details of the functions of the SEAL clients and the SEAL servers are described in 3GPP TS 23.434 v17.5.0.

The VAE layer is a layer that supports a V2X application specific layer by interpreting a service provided by the SEAL for V2X application use. The V2X UE includes a VAE client, and the V2X application server includes a VAE server. The functions provided by the VAE client may include, for example, registration of the VAE client to the VAE server for reception of V2X messages, provision of application-level location information to the VAE server, reception of communication configuration information from the VAE server, and support for dynamic group management. The functions provided by the VAE server may include, for example, accepting registration of VAE clients, tracking the location of V2X UEs at the application level, providing communication configuration information, and supporting delivery of V2X messages. A V5-AE is an interface between V2X UEs in the VAE layer. A V1-AE is an interface between a V2X UE and the V2X application server in the VAE layer.

The V2X application specific layer is a layer that provides functionality specific to individual V2X applications with the assistance of the VAE layer. The V2X UE includes a V2X application specific client, and the V2X application server includes a V2X application specific server. A V5-APP is an interface between V2X UEs in the V2X application specific layer. A V1-APP is an interface between the V2X UE and the V2X application server in the V2X application specific layer.

The functions of the V2X UE and the V2X application server that may have such a hierarchical structure in embodiments of the technology according to the present disclosure will be described in detail later.

As understood from FIG. 2, at an application level, V2X communication is treated as end-to-end communication between the V2X UE and the V2X application server, and content of the V2X communication is transparent to base stations and other network nodes along the communication path.

Section 7 of 3GPP TS 23.286 v17.3.0 describes various deployment models for V2X application specific servers and VAE servers. The V2X application specific server and the VAE server may be physically co-located in a single apparatus, or may be located in separate apparatuses. Each of these servers may belong to either the domain of a V2X service provider or the domain of a network operator.

### 2. Embodiment of V2X Communication System

### 2-1. Outline of System

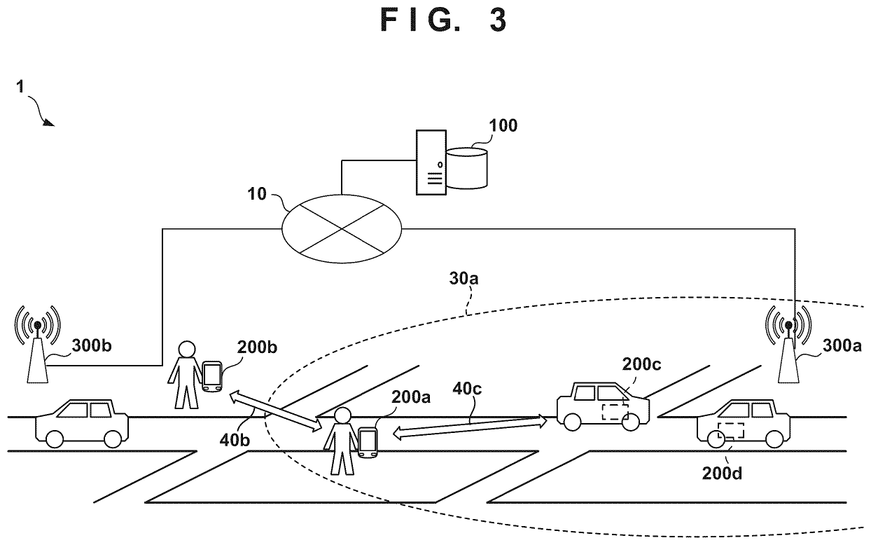

FIG. 3 is a schematic diagram illustrating an example of a configuration of a V2X communication system 1 according to an embodiment. Referring to FIG. 3, the V2X communication system 1 includes a server apparatus 100, UEs 200a, 200b, 200c, and 200d, and base stations 300a and 300b.

Note that, in the following description, in a case where it is not necessary to distinguish the UEs 200a, 200b, 200c, and 200d from each other, they are collectively referred to as the UE 200 by omitting the character at the end of the reference numeral. The same applies to the base stations 300a and 300b (base station 300) and other components.

The server apparatus 100 is a V2X application server that provides a V2X service for the purpose of improving road safety. The server apparatus 100 is connected to a plurality of base stations including the base stations 300a and 300b via a network 10. The network 10 may be, for example, a 5G core network or a combination of a 5G core network and an IP network.

The UE 200 is a terminal apparatus that uses the V2X service provided by the server apparatus 100. In the example of FIG. 3, the UE 200a and the UE 200b are pedestrian terminals, and the UE 200c and the UE 200d are in-vehicle terminals. For example, the UE 200a located in a cell 30a can establish a radio link with the base station 300a to receive downlink data from the base station 300a and transmit uplink data to the base station 300a. In addition, the UE 200a can perform communication with other V2X UEs existing in the vicinity via the sidelink under the assistance (e.g., scheduling of resources or pre-assignment of resource pools) of the base station 300a. For example, FIG. 3 illustrates a sidelink 40b between the UE 200a and the UE 200b and a sidelink 40c between the UE 200a and the UE 200c. Of course, UEs 200 other than UE 200a can also communicate with neighboring V2X UEs via a sidelink.

The base station 300 may be, for example, a gNB or an ng-eNB, and relays communication between the UE 200 and the server apparatus 100. In the example of FIG. 3, the base station 300a serves UEs 200 in the cell 30a, and the base station 300b serves UEs 200 in a cell different from the cell 30a. Broadcasting of information from the base station 300 to a plurality of UEs 200 in a cell is performed on a physical broadcast channel (PBCH). Transmission of downlink data from the base station 300 to a particular UE 200 is performed on a physical downlink shared channel (PDSCH). Transmission of uplink data from a particular UE 200 to the base station 300 is performed on a physical uplink shared channel (PUSCH). Control signaling for controlling the data transmission (e.g., downlink assignment, scheduling request, uplink grant, retransmission control, and the like) is performed on various control channels including a physical downlink control channel (PDCCH) and a physical uplink control channel (PUCCH).

In the present embodiment, the UE 200 can operate in one of a plurality of operation modes including a continuous reception mode and a discontinuous reception (DRX) mode. The operation mode herein may be a mode related to all of downlink, uplink, and sidelink, or may be a mode related to only sidelink. For example, when operating in the continuous reception mode, the UE 200 monitors all the candidate resources of the sidelink and receives a V2X message broadcast, groupcast, or unicast to the self-apparatus. On the other hand, when operating in the DRX mode, the UE 200 monitors only the candidate resources included in an On-duration that periodically arrives according to a DRX cycle, and receives a V2X message transmitted on the candidate resources. The UE 200 can reduce power consumption and extend battery life by operating in the DRX mode.

In addition, in the present embodiment, it is assumed that at least some UEs 200 can, in a case where a threat related to road safety is detected, transmit an alarm message notifying of the presence of the threat on the sidelink. The UE 200 may detect a safety threat using any known method. For example, the UE 200 mounted on a vehicle may recognize one or more of the following as threats:
Speed or acceleration of self-vehicle or other vehicle exceeding reference value
Deviation of self-vehicle or other vehicle from correct lane of travel
Physiological abnormality of driver of self-vehicle
Detection of alcohol component from exhalation of driver of self-vehicle
Detection of contact or collision
Abnormal driving environment (e.g., presence of fallen object or decrease in road surface temperature)

The UE 200 that has detected such a safety threat transmits an alarm message on, for example, a sidelink shared channel (SL-SCH). The alarm message may include type information indicating a type of the detected threat. The server apparatus 100 configures each UE 200 to receive an alarm message transmitted from another UE 200 via the sidelink. When the UE 200 that receives an alarm message alerts the user via a user interface, the user can recognize the threat early and take an appropriate action to ensure safety.

However, when a certain UE 200 is operating in the DRX mode to reduce power consumption, the UE 200 cannot receive an alarm message transmitted from another UE 200 in an OFF-duration of the DRX cycle in a timely manner. Although 3GPP TR 23.776 v17.0.0 proposes that the UE autonomously determine whether to transition to the DRX mode on the basis of the latest road conditions, autonomous determination does not ensure sufficient user safety since the UE is not necessarily capable of recognizing potential threats. On the other hand, if the operation in the DRX mode is uniformly prohibited, power consumption of the UE is not reduced even in a situation with a low risk level, and the battery may be depleted early. Therefore, as will be described in more detail in the next section, in the V2X communication system 1, a mechanism for managing data indicating a risk level for each predefined geographical area and controlling the UE 200 not to operate in the DRX mode in a geographical area with a high risk level is adopted.

### 2-2. Configuration Example of Server Apparatus

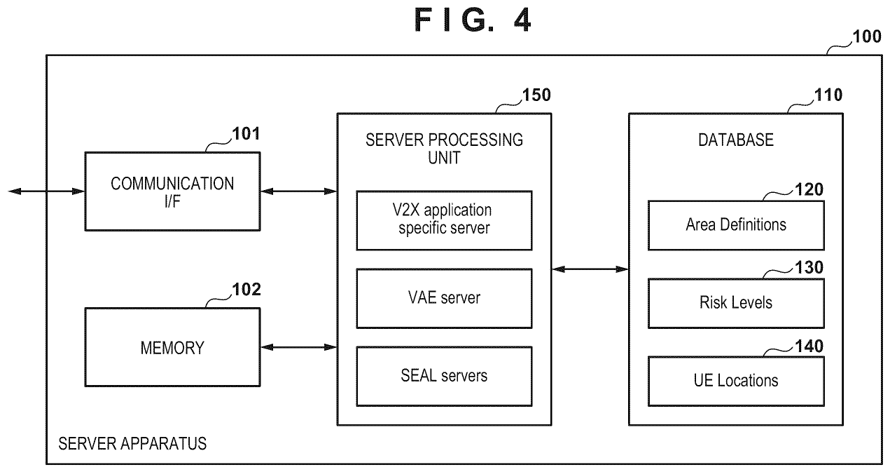

FIG. 4 is a block diagram illustrating an example of a configuration of the server apparatus 100 according to the present embodiment. Referring to FIG. 4, the server apparatus 100 includes a communication interface (I/F) 101, a memory 102, a database 110, and a server processing unit 150.

The communication I/F 101 is a communication unit for the server apparatus 100 to communicate with one or more UEs 200 operating as clients of the V2X application. The communication I/F 101 is connected to the network 10, and can communicate with the UE 200 connected to the base station 300 via one or more network nodes in the network 10 and the base station 300.

The memory 102 may include any combination of a nonvolatile storage medium such as a read only memory (ROM) and a volatile storage medium such as a random access memory (RAM). For example, the ROM prestores computer programs for several server modules described below. The RAM provides a temporary storage area for computation by the server processing unit 150.

The database 110 is a database that stores various data required for providing the V2X application by the server apparatus 100. In the present embodiment, the database 110 includes area definition data 120, risk level data 130, and UE location data 140. Note that although an example in which the server apparatus 100 includes the database 110 will be described here, the database 110 may be implemented in an apparatus (e.g., database server or cloud server) separate from the server apparatus 100 as long as it can be accessed by the server processing unit 150.

The area definition data 120 is data indicating definitions of a plurality of geographical areas for the V2X application provided by the server apparatus 100. The area definition data 120 may include, for example, for each geographical area, the following three data items:
“Area ID”
“Area definition”
“Associated base station”

The “area ID” is an identifier for uniquely identifying each geographical area. The “area definition” is a set of parameters that define the geographic location and shape of each geographical area. For example, for a polygonal geographical area, the “area definition” indicates a set of coordinate values (e.g., latitude and longitude) of N (N is integer greater than or equal to three) vertices. For a circular geographical area, the “area definition” indicates the coordinate values of the center point and the radius. The “associated base station” indicates at least one address (or other identification information) for communication with a base station serving each geographical area.

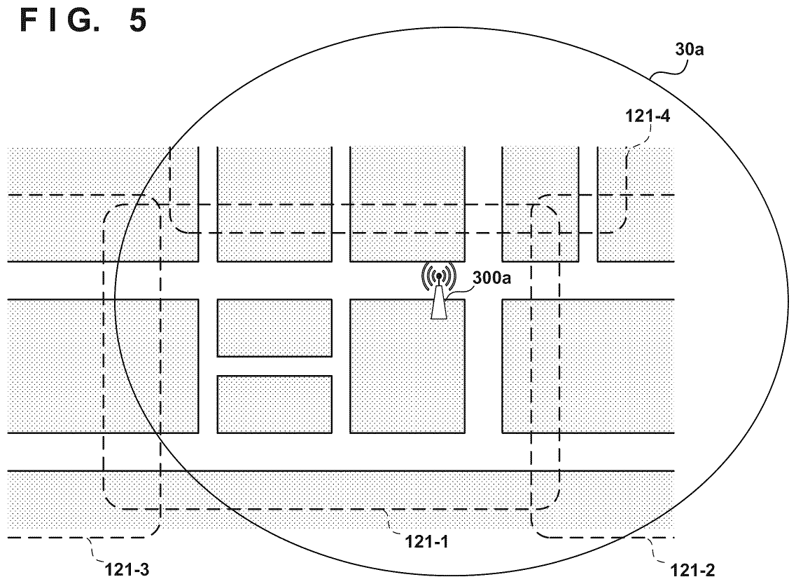

FIG. 5 is an explanatory diagram for describing an example of a definition of a geographical area. Referring to FIG. 5, boundary lines of four geographical areas 121-1, 121-2, 121-3, and 121-4 are indicated by broken lines in a manner superimposed on a road map of an area where the base station 300a is installed. Here, the shape of these geographical areas is substantially rectangular. The geographical areas 121-2, 121-3, and 121-4 are neighboring areas of the geographical area 121-1. FIG. 5 also illustrates a boundary line of the cell 30a of the base station 300a. The geographical area is typically defined in view of the purpose of the V2X application, independent of coverages of cells. For example, in the present embodiment, an area may be divided into a plurality of geographical areas on the basis of differences in road characteristics (e.g., speed limit, number of lanes, and the like) and traffic trends (e.g., amount of pedestrians, frequency of occurrence of traffic congestion, and the like.).

The risk level data 130 is data indicating a risk level determined for each of the plurality of geographical areas defined by the area definition data 120. The risk level data 130 may include, for example, the following three data items:
“Management area”
“Risk level”
“Last-update-at”

The “management area” identifies each of the geographical areas subject to the risk level management by an “area ID” registered in the area definition data 120. The “risk level” is a parameter indicating a risk level determined for the geographical area identified by the “management area”. In the present embodiment, the “risk level” is evaluated in three levels, and indicates any value of “low” meaning that the risk level is the lowest, “medium” meaning that the risk level is medium, and “high” meaning that the risk level is the highest. Note that in another embodiment, the “risk level” may be evaluated in two or four or more levels. The “last-updated-at” indicates the date and time when the value of the “risk level” was last updated for each geographical area.

The UE location data 140 is data for managing locations of the V2X UEs that utilize the V2X application provided by the server apparatus 100. The UE location data 140 may include, for example, the following four data items:
“UE ID”
“Location”
“Camping area”
“Last-reported-at”

The “UE ID” is an identifier for uniquely identifying each V2X UE. The “location” indicates the location reported last from each V2X UE. The “camping area” identifies the geographical area corresponding to the location reported last from each V2X UE by an “area ID” registered in the area definition data 120. The “last-reported-at” indicates the date and time when the location was last reported from each V2X UE.

Note that the configuration of the database 110 is not limited to the configuration described here. The database 110 may store additional data, and some data items described above may be omitted. For example, the database 110 may store a user ID and authentication information (e.g., password, authentication key, or the like) for authenticating a user who uses the V2X application provided by the server apparatus 100.

The server processing unit 150 is a functional module that operates as a server of the V2X application. The function of the server processing unit 150 can be implemented by one or more processors (e.g., central processing units (CPUs)) executing computer programs stored in the memory 102. As illustrated in FIG. 4, the server processing unit 150 includes three types of server modules of a V2X application specific server, a VAE server, and SEAL servers. The functional split between these server modules may be as described with reference to FIG. 2.

When the UE 200 operating as a client of the V2X application connects to a base station 300, the server processing unit 150 sets up a communication link (V1-APP/V1-AE/SEAL-UU) for V2X communication with the UE 200 after performing an authentication procedure as necessary.

In addition, the server processing unit 150 configures the UE 200 to receive an alarm message transmitted from another V2X UE via the sidelink. For example, in a case where alarm messages are broadcast on the PC5 interface, the server processing unit 150 configures the UE 200 to monitor for messages having a destination layer 2 ID for broadcast reception on the sidelink resource. In a case where alarm messages are groupcast on the PC5 interface, the server processing unit 150 assigns a group ID for alarm message reception to the UE 200, and configures the UE 200 to monitor for messages having a destination layer 2 ID corresponding to the group ID on the sidelink resource. Alarm messages may be transmitted by unicast, but in terms of quick transmission of the alarm messages, broadcast or groupcast is more advantageous than unicast that requires establishment of a separate PC5 interface.

In addition, the server processing unit 150 manages the risk level of each geographical area indicated by the risk level data 130. For example, the initial value of the “risk level” of the risk level data 130 is determined in advance on the basis of static road characteristics such as a speed limit, the number of lanes, a curvature, separation of a roadway and a sidewalk, and presence of steps in a corresponding geographical area. The server processing unit 150 may update the value of the “risk level” on the basis of a temporal condition or a sunlight condition that may include a season or a time zone (e.g., increase risk level by one level in the evening when visibility is deteriorating). Furthermore, in the present embodiment, the server processing unit 150 updates the value of the “risk level” of the risk level data 130 on the basis of the V2X message received from one or more terminal apparatuses via the communication I/F 101. Each of the terminal apparatuses here may be the UE 200 described with reference to FIG. 3, or may be another type of terminal apparatus (e.g., roadside unit with sensor or camera). For example, in a case where it is determined that the following event has occurred in a certain geographical area on the basis of a V2X message received from a terminal apparatus, the server processing unit 150 may temporarily increase the value of the “risk level” of the geographical area until it is determined that the event has been resolved:
Presence of vehicle satisfying above-described threat detection condition
Vehicle stopping on road
Traffic congestion
Abnormality in driving environment

The server processing unit 150 also tracks the location of the connected UE 200. Specifically, the server processing unit 150 periodically receives location information of the UE 200 via the communication I/F 101 from the connected UE 200. The server processing unit 150 then determines in which geographical area the UE 200 is located on the basis of the received location information, and updates the “location”, “camping area”, and “last-reported-at” of the corresponding record of the UE location data 140. The location information may indicate positional coordinates of a geographical location acquired as a result of positioning in the UE 200 as the location of the UE 200. In this case, the server processing unit 150 can determine to which geographical area the geographical position indicated by the location information belongs on the basis of the “area definition” of the area definition data 120. When the size of the geographical area is equal to or larger than the size of the cell served by the base station 300, the location information may indicate the cell ID of the cell to which the UE 200 is connected as the location. In this case, the server processing unit 150 can determine to which geographical area the cell to which the UE 200 is connected belongs, on the basis of known mapping between the cell ID indicated by the location information and an area ID of the corresponding geographical area. As a result of such location tracking, if it is determined that the UE 200 is located in a geographical area indicated as having a high threat by the risk level data 130, then that UE 200 is not allowed to operate in the DRX mode in this embodiment.

For example, in a case where the risk level data 130 indicates that the risk level of a first geographical area is high, the server processing unit 150 notifies the UE 200 located in the first geographical area that it is not allowed to operate in the DRX mode. In a first embodiment example, this notification is made by transmitting, in response to determining that the UE 200 is located in the first geographical area, a control message indicating that it is not allowed to operate in the DRX mode to the UE 200 via the communication I/F 101. That is, in the first embodiment example, the operation mode of the UE 200 is controlled at the application level.

In a second embodiment example, in a case where the risk level data 130 indicates that the risk level of the first geographical area is high, the server processing unit 150 transmits, to the base station 300 serving the first geographical area via the communication I/F 101, a request message requesting to broadcast control information indicating that V2X UEs located in the first geographical area are not allowed to operate in the DRX mode. That is, in the second embodiment example, the operation mode of the UE 200 is controlled not at the application level but at the radio link level. Upon receiving this request message from the server apparatus 100, the base station 300 includes control information for controlling the operation mode of the UEs 200 in a system information block (SIB) to broadcast the control information over the PBCH, for example. The broadcasted control information includes at least a control parameter indicating whether or not the UE 200 that has received the control information is allowed to operate in the DRX mode.

FIG. 6A illustrates a first example of a format of a control message transmitted to a UE 200 for control of the operation mode. In the first example, a format 160a includes a V2X UE ID 161, a camping area 162, and a DRX prohibited flag 163. The V2X UE ID 161 indicates a UE ID for identifying the UE 200 that is the destination of the control message. The camping area 162 indicates an area ID for identifying a geographical area in which it is determined that the UE 200 identified by the V2X UE ID 161 is located. The DRX prohibited flag 163 is a control parameter indicating whether or not it is allowed to operate in the DRX mode in the geographical area identified by the camping area 162. For example, a value “0” of the DRX prohibited flag 163 indicates that operation in the DRX mode is allowed, and a value “1” of the DRX prohibited flag 163 indicates that operation in the DRX mode is prohibited. Note that the name “prohibited flag” here is merely an example, and other names such as “allowed flag” may be used for the control parameter.

FIG. 6B illustrates a second example of a format of a control message transmitted to a UE 200 for control of the operation mode. In the second example, a format 160b includes a V2X UE ID 161 and a DRX prohibited flag 163.

FIG. 6C illustrates a third example of a format of a control message transmitted to a UE 200 for control of the operation mode. In the third example, a format 160c includes a V2X UE ID 161 and a camping area 162. The format 160c alone does not indicate whether operation in the DRX mode is allowed, and thus may be used in combination with a format 160d described below.

FIG. 6D illustrates a fourth example of a format of a control message transmitted to a UE 200 for control of the operation mode. In the fourth example, a format 160d includes the number of areas 164 and K pairs of an area ID 165-k and a prohibited flag 166-k (k=1, 2, . . . , K). The number of areas 164 indicates the number K of pairs of the area ID and the prohibited flag included in the control message. The area ID 165-k indicates an area ID for identifying a k-th geographical area. The prohibited flag 166-k is a control parameter indicating whether or not it is allowed to operate in the DRX mode in the k-th geographical area. Upon receiving both the control messages in the formats 160c and 160d, the UE 200 can identify the corresponding prohibited flag by looking up, in the control message with the format 160d, the area ID indicated by the camping area 162 of the control message with the format 160c, and become aware of whether or not it is allowed to operate in the DRX mode in the geographical area in which the UE 200 is located.

In the first embodiment example described above, the control message that the server processing unit 150 can transmit to the UE 200 may be any of the following options:
Message A (format 160a)
Message B (format 160b)
Message C (format 160c) and message D (format 160d)

The message A, the message B, or the message C may be transmitted each time the location of the UE 200 changes. On the other hand, after being transmitted to the UE 200 once, the message D need not be transmitted to the same UE 200 again unless the risk level of one or more geographical areas changes. Each message may of course include additional control parameters not illustrated. If the UE 200 can autonomously determine the geographical area in which it is currently located on the basis of its location (e.g., by referring to area definition downloaded in advance), then it is possible to transmit only the message D (format 160d) to the UE 200.

FIG. 6E illustrates an example of a format of a control message broadcast for control of the operation mode. In this example, a format 160e includes M control parameters including a DRX prohibited flag 167. The DRX prohibited flag 167 is a control parameter indicating whether or not the V2X UE that has received the control message is allowed to operate in the DRX mode. For example, a value “0” of the DRX prohibited flag 167 indicates that operation in the DRX mode is allowed, and a value “1” of the DRX prohibited flag 167 indicates that operation in the DRX mode is prohibited. The format 160e may be adopted in, for example, a system information block provided for controlling the sidelink or a system information block provided for controlling the V2X communication.

In the second embodiment example described above, the control information that can be received by the UE 200 may be any of the following options:
System information (format 160d) broadcast from base station and message C (format 160c) received from server apparatus 100
System information (format 160d) broadcast from base station
System information (format 160e) broadcast from base station

The second option may be adopted when the UE 200 can autonomously determine the geographical area in which it is currently located on the basis of its location. The third option may be adopted when operation in the DRX mode is uniformly allowed or prohibited in one cell.

In both of the first and second embodiment examples, the notification that it is not allowed to operate in the DRX mode may be applied to communication via the sidelink. In this case, the UE 200 can reduce power consumption by arranging a periodic Off-duration in the radio link with the base station 300 while operating the sidelink in the continuous reception mode so that an alarm message from another V2X UE can be received in a timely manner. Alternatively, the notification that operation in the DRX mode is not allowed may be applied to the radio link with the base station 300 in addition to the sidelink. In this case, if there is a V2X message transmitted via the base station 300, it is possible to reduce the possibility that user safety is impaired due to a delay in reception of such a V2X message.

### 2-3. Configuration Example of Terminal Apparatus

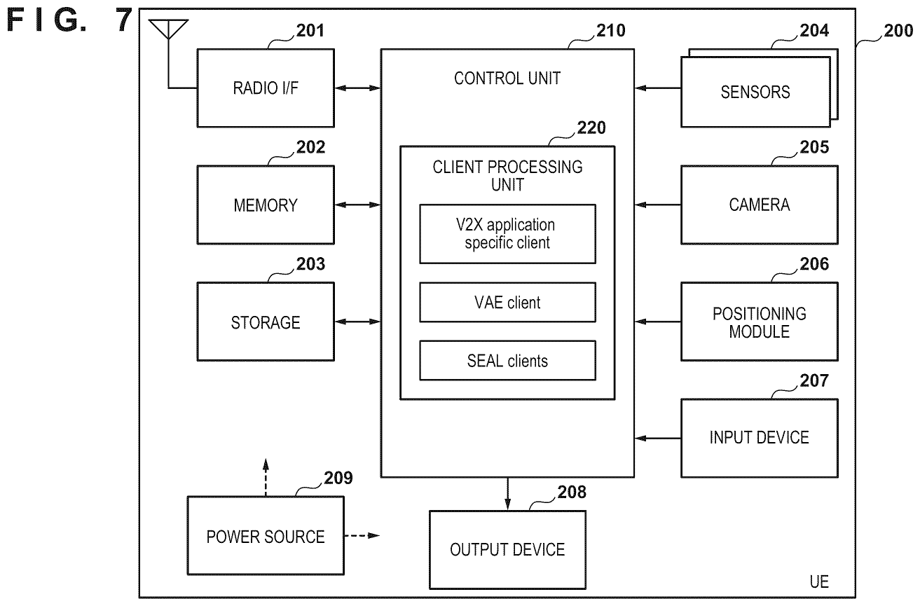

FIG. 7 is a block diagram illustrating an example of a configuration of the UE 200 according to the present embodiment. Referring to FIG. 7, the UE 200 includes a radio I/F 201, a memory 202, a storage 203, sensors 204, a camera 205, a positioning module 206, an input device 207, an output device 208, a power source 209, and a control unit 210.

The radio I/F 201 is a radio communication unit for the UE 200 to perform radio communication. In the present embodiment, the radio I/F 201 can communicate via a radio link established with the base station 300, and can further communicate with another V2X UE via a sidelink. In addition, the radio I/F 201 can operate in one of a plurality of operation modes including the continuous reception mode and the discontinuous reception (DRX) mode.

The memory 202 may include any combination of a nonvolatile storage medium such as a ROM and a volatile storage medium such as a RAM. For example, the ROM prestores computer programs for several client modules running in the control unit 210. The RAM provides a temporary storage area for computation by the control unit 210.

The storage 203 is a storage device for storing large-scale data. The storage 203 may be, for example, a hard disk drive (HDD) or a solid state drive (SSD).

The sensors 204 are a set of various sensors mounted on the UE 200. In a case where the UE 200 is a pedestrian terminal, the sensors 204 may include an acceleration sensor, a gyro sensor, and an orientation sensor. In a case where the UE 200 is an in-vehicle terminal, the sensors 204 may further include sensors such as a distance measuring sensor (e.g., LiDAR or millimeter wave radar) and a biological information sensor in addition to the sensors described above.

The camera 205 is an imaging module capable of imaging the situation around the UE 200. The sensors 204 and the camera 205 may be used to detect a threat related to road safety according to the above-described threat detection condition.

The positioning module 206 is a module for measuring the position of the UE 200. The positioning module 206 may be capable of acquiring the latitude, longitude, and altitude of the current position of the UE 200 using, for example, a global navigation satellite system (GNSS) represented by a global positioning system (GPS). Alternatively or additionally, the positioning module 206 may be capable of estimating the current position of the UE 200 on the basis of a known absolute position of the connected base station and a relative position from the base station.

The input device 207 is a device for the UE 200 to receive an instruction and information input from the user. The input device 207 includes, for example, one or more of a touch sensor, a button, a switch, a keypad, and a microphone.

The output device 208 is a device for the UE 200 to output information or a signal to the user. The output device 208 includes, for example, one or more of a display, a speaker, a light, and a vibrator.

The power source 209 is a rechargeable battery for supplying power to each unit of the UE 200 via a power line partially illustrated in FIG. 7. The supply of power from the power source 209 is controlled by the control unit 210. For example, when the radio I/F 201 operates in the DRX mode, the power supplied from the power source 209 to the radio I/F 201 is reduced in the periodically arriving Off-duration.

The control unit 210 includes one or more processors, and controls the overall functions of the UE 200 by executing a computer program stored in the memory 202. For example, the control unit 210 functions as a client processing unit 220 that operates as a client of the V2X application. The client processing unit 220 includes three types of client modules: a V2X application specific client, a VAE client, and SEAL clients. The functional split between these client modules may be as described with reference to FIG. 2. The control unit 210 may also have various other functions of a general pedestrian terminal or an in-vehicle terminal, but here, for the sake of simplicity of description, the functions of the client processing unit 220 will be mainly described.

The client processing unit 220 is configured by the server processing unit 150 of the server apparatus 100 to receive an alarm message regarding road safety sent from another V2X UE via the sidelink. In a case where the alarm message is received via the sidelink, the client processing unit 220 alerts the user via the user interface of the UE 200 so that the user can take an appropriate action for ensuring safety. For example, the alert may be made to the user by displaying a warning text or icon on the display of the output device 208, outputting a warning sound or a warning voice from the speaker, or ringing the vibrator.

The client processing unit 220 may be capable of detecting a safety threat according to one or more of the above-described threat detection conditions on the basis of sensor data input from the sensors 204 or video data input from the camera 205. In a case where a safety threat is detected, the client processing unit 220 alerts the user and causes the radio I/F 201 to transmit an alarm message on a sidelink communication resource. As described above, the alert message may be transmitted in any of broadcast, groupcast, or unicast. Note that it is not necessary for the client processing units 220 of all the UEs 200 to have the function of transmitting the alarm message.

The client processing unit 220 periodically reports location information indicating the latest location of the UE 200 acquired by the positioning module 206 to the server apparatus 100. The V2X message for reporting the location information is transmitted to the server apparatus 100 via the radio I/F 201 and the base station 300 to which it is connected. As described above, the server processing unit 150 of the server apparatus 100 determines in which geographical area the UE 200 is located according to the report of the location information. The V2X message transmitted to the server apparatus 100 may include information for updating the risk level for each geographical area managed by the server processing unit 150. For example, the client processing unit 220 may transmit sensor data input from the sensors 204 to the server apparatus 100. Furthermore, the client processing unit 220 may notify the server apparatus 100 that a safety threat has been detected in accordance with any of the threat detection conditions. Furthermore, the client processing unit 220 may perform more advanced processing such as determination of a stopped vehicle, determination of traffic congestion, or determination of abnormality of a travel environment, and notify the server apparatus 100 of the determination result.

In the present embodiment, the client processing unit 220 receives a control message from the server apparatus 100 via the radio I/F 201 as a response to the transmission of the location information. The control message may include an area ID for identifying a geographical area in which the UE 200 is determined to be located among a plurality of predefined geographical areas for the V2X application. Then, in a case where it is not allowed to operate in the DRX mode in the geographical area in which the UE 200 is located, the client processing unit 220 controls the radio I/F 201 not to operate in the DRX mode.

In the first embodiment example, the control message received as a response to the transmission of the location information may include a control parameter indicating whether or not the UE 200 is allowed to operate in the DRX mode. For example, when it is determined that the UE 200 is located in a first geographical area indicated as having a high risk level by the risk level data 130, the above control parameter indicates a value which means that operation in the DRX mode is not allowed (prohibited). In this case, the client processing unit 220 controls the radio I/F 201 to operate in the continuous reception mode at least for sidelink communication (i.e., DRX mode is not applied to sidelink.). On the other hand, when it is determined that the UE 200 is located in a second geographical area indicated by the risk level data 130 that the risk level is not high, the above control parameter indicates a value which means that operation in the DRX mode is allowed. In this case, the client processing unit 220 can determine whether or not to operate the radio I/F 201 in the DRX mode in consideration of other factors such as the remaining battery level, for example.

In the second embodiment example, the client processing unit 220 receives, via the radio I/F 201, control information broadcast from the base station 300 serving the geographical area in which the UE 200 is located. This control information includes at least a control parameter indicating whether or not the UE 200 is allowed to operate in the DRX mode. Similarly to the first embodiment example, the client processing unit 220 can control the operation mode of the radio I/F 201 according to the value of the control parameter.

The control message or the control information that can be received by the UE 200 in the first embodiment example and the second embodiment example may have the format described above with reference to FIGS. 6A to 6E.

In a case where the control information having the format 160d described with reference to FIG. 6D is provided, the client processing unit 220 can be made aware of whether or not it is allowed to operate in the DRX mode in the new geographical area as soon as the area ID of the new geographical area is acquired after moving across a boundary between geographical areas. In a case where the area definition of each geographical area is known to the UE 200, the client processing unit 220 can acquire the area ID of the new geographical area without requiring communication with the server apparatus 100. In a scenario in which the UE 200 may temporarily exit to the outside of the coverage of the V2X communication system 1, it is beneficial that such an autonomous DRX mode permission/prohibition determination is possible.

As described above, in both of the first embodiment example and the second embodiment example, the control of the operation mode of the radio I/F 201 according to the control parameter may be applied only to sidelink communication, or may be applied to both sidelink communication and communication with the base station 300.

### 2-4. Configuration Example of Base Station

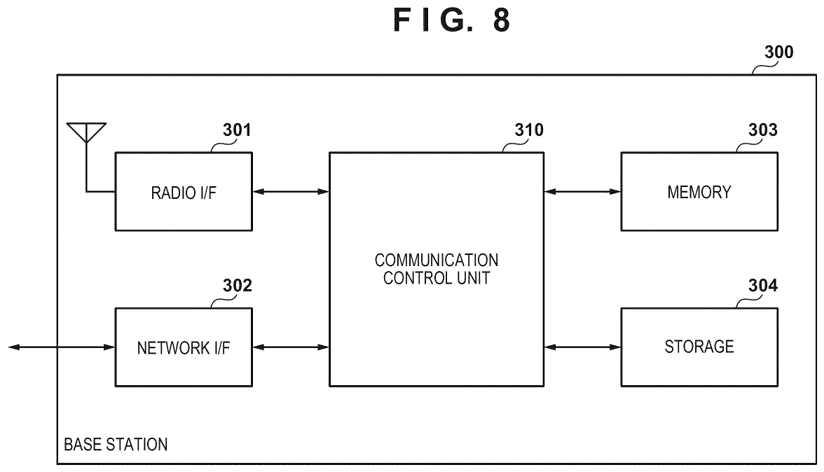

FIG. 8 is a block diagram illustrating an example of a configuration of the base station 300 according to the present embodiment. Referring to FIG. 8, the base station 300 includes a radio I/F 301, a network I/F 302, a memory 303, a storage 304, and a communication control unit 310.

The radio I/F 301 is a radio communication unit for the base station 300 to provide radio access to one or more UEs 200 in a cell 30. For example, when the coverage of the cell 30 of the base station 300 includes a first geographical area, the base station 300 can wirelessly communicate at least with the UE 200 located in the first geographical area via the radio I/F 301.

The network I/F 302 is a network communication unit for the base station 300 to communicate with a network node in the network 10 and other apparatuses connected to the network 10. The base station 300 can communicate with the server apparatus 100 via the network I/F 302, for example.

The memory 303 may include any combination of a nonvolatile storage medium such as a ROM and a volatile storage medium such as a RAM. For example, the ROM stores in advance a computer program executed by the communication control unit 310. The RAM provides a temporary storage area for computation by the communication control unit 310. The storage 304 is a storage device for storing large-scale data. The storage 304 may be, for example, an HDD or an SSD.

The communication control unit 310 includes one or more processors, and executes a computer program stored in the memory 303 to control radio communication performed by the radio I/F 301 and network communication performed by the network I/F 302. For example, when a connection request from the UE 200 is received by the radio I/F 301, the communication control unit 310 establishes a radio link between the UE 200 and the radio I/F 301. In addition, when the UE 200 uses the V2X application provided by the server apparatus 100, the communication control unit 310 mediates communication at the application level between the UE 200 and the server apparatus 100. Further, the communication control unit 310 schedules a resource of the sidelink or assigns a resource pool for the sidelink for the UE 200 which is a V2X UE. This enables the UE 200 to perform radio communication via a radio link with the base station 300 and a sidelink with another V2X UE.

In an embodiment example, the communication control unit 310 is involved in controlling the operation mode of the UE 200. For example, when it is determined that the risk level of the first geographical area is high, the server apparatus 100 transmits, to the base station 300, a request message for requesting broadcast of control information to prevent V2X UEs located in the first geographical area from operating in the DRX mode. When this request message is received via the network I/F 302, the communication control unit 310 causes the radio I/F 301 to broadcast control information indicating that the V2X UEs located in the first geographical area are not allowed to operate in the DRX mode. The format of the broadcasted control information may be the format described above with reference to the second embodiment example.

As an example, the radio I/F 301 may include the control information in a system information block for controlling the sidelink (e.g., SIB 12) and broadcast the control information. In this case, the operation mode of the terminal apparatus using the sidelink for a purpose different from V2X communication can also be commonly controlled by the control information. As another example, the radio I/F 301 may include the control information in a system information block for controlling V2X communication (e.g., SIB 13 or SIB 14) and broadcast the control information. In this case, a terminal apparatus not involved in V2X communication can ignore the system information block, and the operation mode of such a terminal apparatus is not affected by the control information.

### 3. Flow of Processing

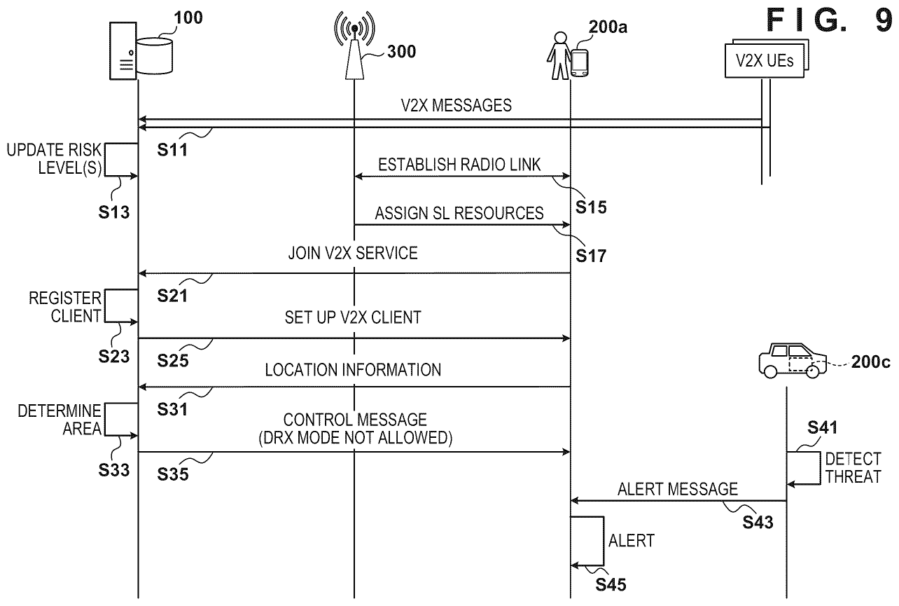

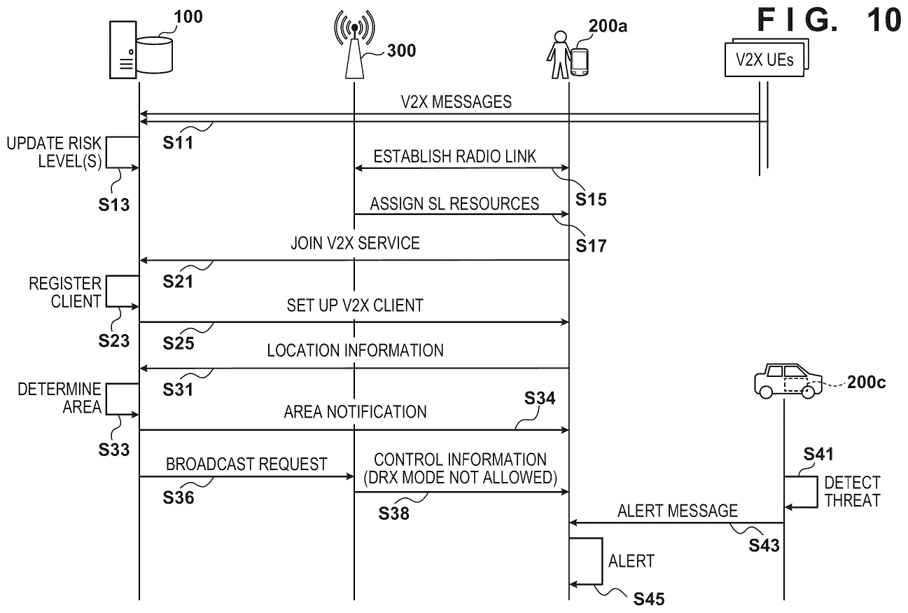

In this section, an example of a flow of processing that can be executed in the above-described V2X communication system 1 will be described with reference to sequence diagrams of FIGS. 9 and 10. Note that in the following description, a processing step is abbreviated as S (step).

### 3-1. First Embodiment Example

FIG. 9 is a sequence diagram illustrating an example of a flow of processing according to the first embodiment example. The illustrated processing mainly involves the server apparatus 100, the UE 200a, the UE 200c, and the base station 300. Note, however, that a plurality of V2 XUEs other than the UEs 200a and 200c also perform V2X communication with the server apparatus 100.

First, in S11, the server apparatus 100 receives V2X messages from a plurality of V2X UEs. Each received V2X message may include any information, such as, for example, the speed or acceleration of a traveling vehicle, a location on a road, physiological parameters of the driver, or the state of the traveling environment. In S13, the server processing unit 150 of the server apparatus 100 updates the risk level of each geographical area indicated by the risk level data 130 on the basis of the received V2X messages. Such updating can be performed periodically or intermittently while the server apparatus 100 is operating.

Then, when the UE 200a enters coverage of the cell 30 served by the base station 300, in S15, a radio link between the UE 200a and the base station 300 is established. Next, in S17, the communication control unit 310 of the base station 300 schedules a resource of the sidelink or assigns a resource pool for the sidelink for the UE 200a which is a V2X UE.

Next, in S21, the client processing unit 220 of the UE 200a accesses the server apparatus 100 using a URL of the server apparatus 100 stored in advance in the memory 202, for example, and participates in the V2X service provided by the server apparatus 100. In S23, the server processing unit 150 of the server apparatus 100 registers the UE 200a as a connected client (when authentication of UE 200a is successful). Then, in S25, the server processing unit 150 sets up a communication link with the UE 200a. At this time, the server processing unit 150 configures the UE 200a to receive an alarm message transmitted from another V2X UE via the sidelink.

Next, in S31, the client processing unit 220 of the UE 200a transmits location information indicating the latest location of the UE 200a to the server apparatus 100. In S33, the server processing unit 150 of the server apparatus 100 that has received the location information determines in which geographical area the UE 200a is located. Here, it is assumed that the UE 200a is determined to be located in the first geographical area indicated as having a high risk level (e.g., value of “risk level” is “high”) by the risk level data 130. In S35, the server processing unit 150 transmits a control message indicating that it is not allowed to operate in the DRX mode to the UE 200a. The client processing unit 220 of the UE 200a that has received the control message controls the radio I/F 201 not to operate in the DRX mode (or, if operation is already performed in DRX mode, to transition to the continuous reception mode).

Thereafter, in S41, the UE 200c, which is an in-vehicle terminal participating in the same V2X service, detects a threat related to road safety. In S43, the client processing unit 220 of the UE 200c transmits (e.g., broadcast or groupcast) an alarm message over a communication resource of the sidelink. The radio I/F 201 of the UE 200a continuously monitors broadcast or groupcast resources of the sidelink without operating in the DRX mode, and receives the alarm message sent from the UE 200c in a timely manner. In S45, in response to the reception of the alarm message, the client processing unit 220 of the UE 200a alerts the user via the user interface so that the user can take an appropriate action for ensuring safety.

### 3-2. Second Embodiment Example

FIG. 10 is a sequence diagram illustrating an example of a flow of processing according to the second embodiment example. The illustrated processing mainly involves the server apparatus 100, the UE 200a, the UE 200c, and the base station 300. Note, however, that a plurality of V2X UEs other than the UEs 200a and 200c also perform V2X communication with the server apparatus 100.

The processing steps of S11 to S33 may be similar to the corresponding processing steps in the first embodiment example described with reference to FIG. 9. Therefore, descriptions of these processing steps are omitted here.

After determining the geographical area in which the UE 200a is located in S33, the server processing unit 150 of the server apparatus 100 transmits a control message including an area ID for identifying the determined geographical area to the UE 200a in S34. Note that in a case where the geographical area on which the UE 200a is camping can be autonomously determined, the area notification in S34 may be omitted. Here, it is assumed that the UE 200a is determined to be located in the first geographical area indicated as having a high risk level by the risk level data 130. Then, in S36, the server processing unit 150 requests the base station 300 serving the first geographical area to broadcast control information indicating that V2X UEs in the first geographical area are not allowed to operate in the DRX mode. In S38, the communication control unit 310 of the base station 300 that has received the broadcast request causes the radio I/F 301 to broadcast control information indicating that the V2XUEs in the first geographical area are not allowed to operate in the DRX mode. The client processing unit 220 of the UE 200a that has received the control information broadcast from the base station 300 controls the radio I/F 201 not to operate in the DRX mode (or, if operation is already performed in DRX mode, to transition to the continuous reception mode).

The subsequent processing steps of S41 to S45 may be similar to the corresponding processing steps in the first embodiment example described with reference to FIG. 9. Therefore, descriptions of these processing steps are omitted here.

### 4. Summary of Embodiments

The above embodiments disclose at least the following server apparatus, communication control methods, terminal apparatus, and base station.

1. A server apparatus (100) of the above embodiments comprises:
a communication unit (101) adapted to communicate with one or more terminal apparatuses (200) that operate as clients of a vehicle-to-everything, V2X, application, and
a server processing unit (150) adapted to operate as a server of the V2X application, where
the server processing unit is capable of accessing a database (130) indicating a risk level for each of a plurality of geographical areas (121-1, 121-2, 121-3, 121-4) predefined for the V2X application, and
the server processing unit is adapted to
   receive (S31) location information of a first terminal apparatus via the communication unit,
   determine (S33), on the basis of the location information, that the first terminal apparatus is located in a first geographical area of the plurality of geographical areas, and
   when the database indicates that a risk level of the first geographical area is high, notify (S35, S36) the first terminal apparatus that it is not allowed to operate in a discontinuous reception mode.

According to this embodiment, it is possible to prevent the terminal apparatus from operating in the discontinuous reception mode based on autonomous control despite a situation in which the terminal apparatus is located in a geographical area with a high risk level. Hence, the terminal apparatus can receive a safety message in a timely manner, so that safety of the user related to road traffic is further improved. When located in a geographical area with a low risk level, the terminal apparatus is allowed to operate in the discontinuous reception mode, so that an opportunity to utilize the discontinuous reception mode to reduce power consumption is also ensured.

2. In the above embodiments, notifying the first terminal apparatus that it is not allowed to operate in the discontinuous reception mode may include:
in response to the determination that the first terminal apparatus is located in the first geographical area, transmitting (S35), to the first terminal apparatus via the communication unit, a control message indicating that it is not allowed to operate in the discontinuous reception mode.

According to this embodiment, communication for controlling the operation mode of the terminal apparatus is performed at an application level between the server and the client of the V2X application. That is, the content of the communication is transparent to the base station located along the communication path. Therefore, it is possible to define a plurality of geographical areas on the basis of the situation of road traffic and to achieve control of the operation mode in units of the geographical areas without being affected by the arrangement of the base stations.

3. In the above embodiments, notifying the first terminal apparatus that it is not allowed to operate in the discontinuous reception mode may include:
requesting (S36) a base station (300) serving the first geographical area to broadcast control information indicating that a terminal apparatus located in the first geographical area and operating as a client of the V2X application is not allowed to operate in the discontinuous reception mode.

According to this embodiment, communication for controlling the operation mode of the terminal apparatus is performed at a radio link level in which a base station intervenes. In this case, the terminal apparatus can immediately reflect the instructed control content in the radio interface of the lower layer without delivering the received control information to the application layer.

4. In the above embodiments, the control information may include, for each of the first geographical area and at least one second geographical area in a same cell as the first geographical area, an identifier (165) for identifying the geographical area, and a parameter (166) that indicates whether or not it is allowed to operate in the discontinuous reception mode in the geographical area.

According to this embodiment, when moving across a boundary of the geographical areas, the terminal apparatus can be made aware of whether or not it is allowed to operate in the discontinuous reception mode in the new geographical area on the basis of the identifier for identifying the new geographical area and the received control information.

5. In the above embodiments, the server processing unit may be adapted to update (S13) the risk level indicated by the database on the basis of a V2X message received from one or more second terminal apparatuses via the communication unit.

According to this embodiment, the conditions of a wide range of roads that change over time can be dynamically reflected in the risk level indicated by the database. Therefore, it is possible to appropriately control the operation mode of the terminal apparatus not to transition to the discontinuous reception mode in a geographical area where there is a potential risk that is difficult to recognize by the single terminal apparatus.

6. In the above embodiments, the server processing unit may be adapted to configure (S25) the first terminal apparatus to receive an alarm message related to road safety sent from another terminal apparatus via a sidelink.

According to this embodiment, it is possible to cause the terminal apparatus to monitor for an alarm message on the sidelink while preventing the terminal apparatus from transitioning to the discontinuous reception mode in a geographical area in which a potential risk exists. In this way, a possibility that the terminal apparatus misses an alarm message informing a threat related to road safety is minimized, so that high safety related to road traffic can be achieved.

7. In the above embodiments, the notification (163, 166, 167) that it is not allowed to operate in the discontinuous reception mode may be applied to communication via the sidelink.

According to this embodiment, the terminal apparatus can operate the radio link with the base station in the discontinuous reception mode to reduce power consumption while operating the sidelink in the continuous reception mode to receive the alarm message in a timely manner.

8. A communication control method of the above embodiments is a communication control method performed by a server apparatus (100) adapted to operate as a server of a vehicle-to-everything, V2X, application for controlling V2X communication by a terminal apparatus (200) that operates as a client of the V2X application,
the server apparatus being capable of accessing a database (130) indicating a risk level for each of a plurality of geographical areas (121-1, 121-2, 121-3, 121-4) predefined for the V2X application, where
the communication control method comprises:
receiving (31) location information of a first terminal apparatus;
determining (S33), on the basis of the location information, that the first terminal apparatus is located in a first geographical area of the plurality of geographical areas; and
when the database indicates that a risk level of the first geographical area is high, notifying (S35, S36) the first terminal apparatus that it is not allowed to operate in a discontinuous reception mode.

According to this embodiment, it is possible to prevent the terminal apparatus from operating in the discontinuous reception mode based on autonomous control despite a situation in which the terminal apparatus is located in a geographical area with a high risk level. Hence, the terminal apparatus can receive a safety message in a timely manner, so that safety of the user related to road traffic is further improved. When located in a geographical area with a low risk level, the terminal apparatus is allowed to operate in the discontinuous reception mode, so that an opportunity to utilize the discontinuous reception mode to reduce power consumption is also ensured.

9. A terminal apparatus (200) of the above embodiments comprises:
a radio communication unit (201) adapted to perform radio communication via a radio link between the terminal apparatus and a base station (300) and a sidelink between the terminal apparatus and another terminal apparatus (200), and
a client processing unit (220) adapted to operate as a client of a vehicle-to-everything, V2X, application and receive an alarm message related to road safety sent from such another terminal apparatus via the sidelink, where
the radio communication unit is adapted to be operable in one of a plurality of operation modes including a continuous reception mode and a discontinuous reception mode, and
the client processing unit is adapted to
   transmit (S31) location information of the terminal apparatus to a server apparatus operating as a server of the V2X application via the radio communication unit, and
   control the radio communication unit not to operate in the discontinuous reception mode when a notification is received (S35, S38) that it is not allowed to operate in the discontinuous reception mode in a first geographical area in which the terminal apparatus is located among a plurality of geographical areas predefined for the V2X application.

According to this embodiment, in a case where the terminal apparatus is located in a geographical area having a high risk level, the terminal apparatus refrains from operating in the discontinuous reception mode not based on autonomous control but based the notification from the server apparatus. Therefore, in a situation where there is a potential risk that is difficult for the terminal apparatus to recognize, a possibility of missing an alarm message informing a threat related to road safety due to operation in the discontinuous reception mode can be minimized. When located in a geographical area with a low risk level, the terminal apparatus is allowed to operate in the discontinuous reception mode, so that an opportunity to utilize the discontinuous reception mode to reduce power consumption is also ensured.

10. In the above embodiments, the client processing unit may be adapted to receive (S35) a control message indicating whether or not it is allowed to operate in the discontinuous reception mode from the server apparatus via the radio communication unit as a response to the transmission of the location information.

According to this embodiment, a control message for controlling the operation mode of the terminal apparatus is received from the server apparatus through communication at an application level. Therefore, it is possible to control the operation mode in units of geographical areas regardless of the arrangement of the base stations.

11. In the above embodiments, the radio communication unit may be adapted to receive (S38) control information broadcast from a base station serving the first geographical area, and
the control information indicates whether or not a terminal apparatus located in the first geographical area and operating as a client of the V2X application is allowed to operate in the discontinuous reception mode.

According to this embodiment, the terminal apparatus can immediately reflect the instructed control content in the radio interface of the lower layer without delivering the control information broadcast from the base station to the application layer.

12. In the above embodiments, the control information may include, for each of the first geographical area and at least one second geographical area in a same cell as the first geographical area, an identifier (165) for identifying the geographical area, and a parameter (166) that indicates whether or not it is allowed to operate in the discontinuous reception mode in the geographical area.

According to this embodiment, when moving across a boundary of the geographical areas, the terminal apparatus can be made aware of whether or not it is allowed to operate in the discontinuous reception mode in the new geographical area on the basis of the identifier for identifying the new geographical area and the received control information.

13. In the above embodiments, the client processing unit may be adapted to alert (S45) a user via a user interface of the terminal apparatus in a case where the alarm message is received (S43) via the sidelink.

According to this embodiment, in a geographical area in which a potential risk exists, the terminal apparatus reliably receives the alarm message over the sidelink and alerts the user, so that the user of the terminal apparatus can take an action to ensure safety against a threat related to road safety in a timely manner.

14. In the above embodiments, the client processing unit may be adapted not to apply the discontinuous reception mode to the sidelink in a case where it is not allowed to operate in the discontinuous reception mode.

According to this embodiment, the terminal apparatus can operate the radio link with the base station in the discontinuous reception mode to reduce power consumption while operating the sidelink in the continuous reception mode to receive an alarm message in a timely manner.

15. A communication control method of the above embodiments is a communication control method performed by a terminal apparatus (200) operating as a client of a vehicle-to-everything, V2X, application for controlling V2X communication by the terminal apparatus,
the terminal apparatus including a radio communication unit (201) adapted to perform radio communication via a radio link between the terminal apparatus and a base station (300) and a sidelink between the terminal apparatus and another terminal apparatus (200), and
the radio communication unit being operable in one of a plurality of operation modes including a continuous reception mode and a discontinuous reception mode,
the communication control method comprises:
transmitting (S31) location information of the terminal apparatus to a server apparatus operating as a server of the V2X application via the radio communication unit;
receiving (S35, S38), via the radio communication unit, a notification that the terminal apparatus is not allowed to operate in the discontinuous reception mode in a first geographical area in which the terminal apparatus is located among a plurality of geographical areas predefined for the V2X application;
controlling the radio communication unit not to operate in the discontinuous reception mode in response to reception of the notification; and
receiving (S43), via the radio communication unit, an alarm message related to road safety sent from such another terminal apparatus using the sidelink.

According to this embodiment, in a case where the terminal apparatus is located in a geographical area having a high risk level, the terminal apparatus refrains from operating in the discontinuous reception mode not based on autonomous control but based on the notification from the server apparatus. Therefore, in a situation where there is a potential risk that is difficult for the terminal apparatus to recognize, a possibility of missing an alarm message informing a threat related to road safety due to operation in a discontinuous reception mode can be minimized. When located in a geographical area with a low risk level, the terminal apparatus is allowed to operate in the discontinuous reception mode, so that an opportunity to utilize the discontinuous reception mode to reduce power consumption is also ensured.

16. A base station (300) of the above embodiments comprises:
a radio communication unit (301) adapted to perform radio communication in at least a first geographical area of a plurality of geographical areas (121-1, 121-2, 121-3, 121-4) predefined for a vehicle-to-everything, V2X, application;
a network communication unit (302) adapted to communicate with a server apparatus (100) operating as a server of the V2X application; and
a control unit (310) adapted to control communication performed by the radio communication unit and the network communication unit, where
the control unit is adapted to, in response to a request message received (S36) via the network communication unit from the server apparatus that has determined not to allow one or more terminal apparatuses (200) located in the first geographical area and operating as clients of the V2X application to operate in a discontinuous reception mode, cause (S38) the radio communication unit to broadcast control information indicating that the one or more terminal apparatuses are not allowed to operate in the discontinuous reception mode.

According to this embodiment, it is possible to prevent the terminal apparatus from operating in the discontinuous reception mode despite a situation in which the terminal apparatus is located in a geographical area with a high risk level. In addition, it is also possible to ensure an opportunity for a terminal apparatus located in a geographical area with a low risk level to reduce power consumption by utilizing the discontinuous reception mode.

17. In the above embodiments, the control unit may be adapted to cause the radio communication unit to include the control information in a system information block (160e) for controlling a sidelink and broadcast the control information.

According to this embodiment, the operation mode of the terminal apparatus using the sidelink for various purposes can be uniformly controlled by the control information broadcast in the system information block having a common format.

18. In the above embodiments, the control unit may be adapted to cause the radio communication unit to include the control information in a system information block (160e) for controlling V2X communication and broadcast the control information.

According to this embodiment, a terminal apparatus that is not involved in V2X communication can ignore the system information block carrying the above control information. Therefore, such a terminal apparatus can reduce power consumption by using the discontinuous reception mode regardless of the above control information.

19. A communication control method of the above embodiments is a communication control method performed by a base station (300) for controlling vehicle-to-everything, V2X, communication by a terminal apparatus (200) that operates as a client of a V2X application,
the base station including a radio communication unit (301) adapted to perform radio communication in at least a first geographical area among a plurality of geographical areas (121-1, 121-2, 121-3, 121-4) predefined for the V2X application, and a network communication unit (302) adapted to communicate with a server apparatus (100) that operates as a server of the V2X application,
the communication control method comprises:
receiving (S36), via the network communication unit, a request message from the server apparatus that has determined not to allow one or more terminal apparatuses located in the first geographical area and operating as clients of the V2X application to operate in a discontinuous reception mode, and
in response to receiving the request message, causing (S38) the radio communication unit to broadcast control information indicating that the one or more terminal apparatuses are not allowed to operate in the discontinuous reception mode.

According to this embodiment, it is possible to prevent the terminal apparatus from operating in the discontinuous reception mode despite a situation in which the terminal apparatus is located in a geographical area with a high risk level. In addition, it is also possible to ensure an opportunity for a terminal apparatus located in a geographical area with a low risk level to reduce power consumption by utilizing the discontinuous reception mode.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A server apparatus comprising
a communication unit adapted to communicate with one or more terminal apparatuses that operate as clients of a vehicle-to-everything, V2X, application, and
a server processing unit adapted to operate as a server of the V2X application, wherein
the server processing unit is capable of accessing a database indicating a risk level for each of a plurality of geographical areas predefined for the V2X application, and
the server processing unit is adapted to
receive location information of a first terminal apparatus via the communication unit,
determine, on the basis of the location information, that the first terminal apparatus is located in a first geographical area of the plurality of geographical areas, and
when the database indicates that a risk level of the first geographical area is high, notify the first terminal apparatus that it is not allowed to operate in a discontinuous reception mode.

2. The server apparatus according to claim 1, wherein
notifying the first terminal apparatus that it is not allowed to operate in the discontinuous reception mode includes
in response to the determination that the first terminal apparatus is located in the first geographical area, transmitting, to the first terminal apparatus via the communication unit, a control message indicating that it is not allowed to operate in the discontinuous reception mode.

3. The server apparatus according to claim 1, wherein
notifying the first terminal apparatus that it is not allowed to operate in the discontinuous reception mode includes
requesting a base station serving the first geographical area to broadcast control information indicating that a terminal apparatus located in the first geographical area and operating as a client of the V2X application is not allowed to operate in the discontinuous reception mode.

4. The server apparatus according to claim 3, wherein the control information includes, for each of the first geographical area and at least one second geographical area in a same cell as the first geographical area, an identifier for identifying the geographical area, and a parameter that indicates whether or not it is allowed to operate in the discontinuous reception mode in the geographical area.

5. The server apparatus according to claim 1, wherein the server processing unit is adapted to update the risk level indicated by the database on the basis of a V2X message received from one or more second terminal apparatuses via the communication unit.

6. The server apparatus according to claim 1, wherein the server processing unit is adapted to configure the first terminal apparatus to receive an alarm message related to road safety sent from another terminal apparatus via a sidelink.

7. The server apparatus according to claim 6, wherein the notification that it is not allowed to operate in the discontinuous reception mode is applied to communication via the sidelink.

8. A communication control method performed by a server apparatus adapted to operate as a server of a vehicle-to-everything, V2X, application for controlling V2X communication by a terminal apparatus that operates as a client of the V2X application,
the server apparatus being capable of accessing a database indicating a risk level for each of a plurality of geographical areas predefined for the V2X application,
the communication control method comprising:
receiving location information of a first terminal apparatus;
determining, on the basis of the location information, that the first terminal apparatus is located in a first geographical area of the plurality of geographical areas; and
when the database indicates that a risk level of the first geographical area is high, notifying the first terminal apparatus that it is not allowed to operate in a discontinuous reception mode.

9. A terminal apparatus comprising
a radio communication unit adapted to perform radio communication via a radio link between the terminal apparatus and a base station and a sidelink between the terminal apparatus and another terminal apparatus, and
a client processing unit adapted to operate as a client of a vehicle-to-everything, V2X, application and receive an alarm message related to road safety sent from such another terminal apparatus via the sidelink, wherein
the radio communication unit is adapted to be operable in one of a plurality of operation modes including a continuous reception mode and a discontinuous reception mode, and
the client processing unit is adapted to
transmit location information of the terminal apparatus to a server apparatus operating as a server of the V2X application via the radio communication unit, and
control the radio communication unit not to operate in the discontinuous reception mode when a notification is received that it is not allowed to operate in the discontinuous reception mode in a first geographical area in which the terminal apparatus is located among a plurality of geographical areas predefined for the V2X application.

10. The terminal apparatus according to claim 9, wherein the client processing unit is adapted to receive a control message indicating whether or not it is allowed to operate in the discontinuous reception mode from the server apparatus via the radio communication unit as a response to the transmission of the location information.

11. The terminal apparatus according to claim 9, wherein
the radio communication unit is adapted to receive control information broadcast from a base station serving the first geographical area, and
the control information indicates whether or not a terminal apparatus located in the first geographical area and operating as a client of the V2X application is allowed to operate in the discontinuous reception mode.

12. The terminal apparatus according to claim 11, wherein the control information includes, for each of the first geographical area and at least one second geographical area in a same cell as the first geographical area, an identifier for identifying the geographical area, and a parameter that indicates whether or not it is allowed to operate in the discontinuous reception mode in the geographical area.

13. The terminal apparatus according to claim 9, wherein the client processing unit is adapted to alert a user via a user interface of the terminal apparatus in a case where the alarm message is received via the sidelink.

14. The terminal apparatus according to claim 9, wherein the client processing unit is adapted not to apply the discontinuous reception mode to the sidelink in a case where it is not allowed to operate in the discontinuous reception mode.

15. A communication control method performed by a terminal apparatus operating as a client of a vehicle-to-everything, V2X, application for controlling V2X communication by the terminal apparatus,
the terminal apparatus including a radio communication unit adapted to perform radio communication via a radio link between the terminal apparatus and a base station and a sidelink between the terminal apparatus and another terminal apparatus, and
the radio communication unit being operable in one of a plurality of operation modes including a continuous reception mode and a discontinuous reception mode,
the communication control method comprising:
transmitting location information of the terminal apparatus to a server apparatus operating as a server of the V2X application via the radio communication unit;
receiving, via the radio communication unit, a notification that the terminal apparatus is not allowed to operate in the discontinuous reception mode in a first geographical area in which the terminal apparatus is located among a plurality of geographical areas predefined for the V2X application;
controlling the radio communication unit not to operate in the discontinuous reception mode in response to reception of the notification; and
receiving, via the radio communication unit, an alarm message related to road safety sent from such another terminal apparatus using the sidelink.

16. A base station comprising:
a radio communication unit adapted to perform radio communication in at least a first geographical area of a plurality of geographical areas predefined for a vehicle-to-everything, V2X, application;
a network communication unit adapted to communicate with a server apparatus operating as a server of the V2X application; and
a control unit adapted to control communication performed by the radio communication unit and the network communication unit, wherein
the control unit is adapted to, in response to a request message received via the network communication unit from the server apparatus that has determined not to allow one or more terminal apparatuses located in the first geographical area and operating as clients of the V2X application to operate in a discontinuous reception mode, cause the radio communication unit to broadcast control information indicating that the one or more terminal apparatuses are not allowed to operate in the discontinuous reception mode.

17. The base station according to claim 16, wherein the control unit is adapted to cause the radio communication unit to include the control information in a system information block for controlling a sidelink and broadcast the control information.

18. The base station according to claim 16, wherein the control unit is adapted to cause the radio communication unit to include the control information in a system information block for controlling V2X communication and broadcast the control information.

19. A communication control method performed by a base station for controlling vehicle-to-everything, V2X, communication by a terminal apparatus that operates as a client of a V2X application,
the base station including a radio communication unit adapted to perform radio communication in at least a first geographical area among a plurality of geographical areas predefined for the V2X application, and a network communication unit adapted to communicate with a server apparatus that operates as a server of the V2X application,
the communication control method comprising
receiving, via the network communication unit, a request message from the server apparatus that has determined not to allow one or more terminal apparatuses located in the first geographical area and operating as clients of the V2X application to operate in a discontinuous reception mode, and
in response to receiving the request message, causing the radio communication unit to broadcast control information indicating that the one or more terminal apparatuses are not allowed to operate in the discontinuous reception mode.
